(19) United States
(12) Patent Application Publication
(10) Pub. No.: US 2026/0262155 A1
(43) Pub. Date: Sep. 3, 2026

(54) X-RAY TUBE ANODE TEMPERATURE

(71) Applicant: KONINKLIJKE PHILIPS N.V., EINDHOVEN (NL)

(72) Inventors: Steffen Weiss, HAMBURG (DE); Carolina Maria Ribbing, AACHEN (DE); Peter Forthmann, SANDESNEBEN (DE); Gereon Vogtmeier, AACHEN (DE); Peter Vernickel, HAMBURG (DE)

(21) Appl. No.: 19/155,595

(22) PCT Filed: Feb. 6, 2024
(86) PCT No.: PCT/EP2024/052833

§ 371 Date: Aug. 12, 2025

(30) Foreign Application Priority Data
Feb. 17, 2023 (EP) 23157186.0

(51) Int. Cl. H05G 1/26; H01J 35/06

(52) U.S. Cl. CPC H05G 1/26; H01J 35/06

(57) ABSTRACT

A system (100) for determining a temperature of an anode (110) of an X-ray tube (120), is provided. The system includes an X-ray tube (120), and an electrical circuit (130). The X-ray tube (120) includes an anode (110) configured to generate X-ray radiation (140) in response to impinging electrons (150), and a cathode (160) for generating the electrons (150) and/or a grid (170) for deflecting the electrons (150) prior to the electrons (150) impinging on the anode (110). The cathode (160) and/or the gid (170) comprises at least one resistive element (180′, 180″) configured to receive thermal radiation emitted by the anode (110). An electrical resistance of the at least one resistive element (180′, 180″) is dependent on a temperature change induced in the resistive element due to the received thermal radiation. The electrical circuit (130) is configured to determine a temperature of the anode (110) based on a measurement of a value of the at least one electrical resistance during the generation of X-ray radiation (140) by the anode.

### FIELD OF THE INVENTION

The present disclosure relates to determining a temperature of an anode of an X-ray tube. A system, a computer-implemented method, and a computer program product, are provided.

### BACKGROUND OF THE INVENTION

X-ray tubes are used to generate X-ray radiation in various application fields. For instance, X-ray tubes are used in the fields of medical imaging systems, non-destructive testing, materials characterisation, and in the security field such as in baggage inspection.

X-ray tubes include an anode that generates X-ray radiation in response to impinging electrons. The electrons that impinge on the anode are generated by a cathode. The cathode includes a resistive element, sometimes referred-to as a “filament”. The resistive element is heated by passing an electrical current through the resistive element in order to generate the electrons via thermionic emission. A potential difference, often in the order of 20-200 kV, is applied between the anode and the cathode. The resulting electrical field accelerates the electrons from the cathode towards the anode, causing them to impinge on the anode. X-ray radiation that includes Bremsstrahlung, or “braking” X-ray radiation is generated by the anode in response to the impinging electrons. The X-ray radiation may also include spectral lines of characteristic X-ray radiation that are generated as a result of the impinging electrons knocking orbital electrons out of the inner electron shells of atoms in the anode. The X-ray radiation is emitted by the X-ray tube in the form of a beam that may be used in the application fields mentioned above.

An X-ray tube may also include a grid arranged between the cathode and the anode. The grid is used to deflect the electrons prior to the electrons impinging on the anode. The electrons are deflected by applying a potential difference between the grid and the cathode and/or the anode. The potential difference may be controlled in order to adjust factors such as the electron beam intensity, and the position and shape of the region of the anode impinged by the electrons. In-turn, these factors affect the shape of the beam of X-ray radiation generated by the anode. The anode, the cathode, and where present, the grid, are housed in a vacuum-containing envelope to provide an undisturbed path for the electrons passing from the cathode to the anode.

X-ray tubes may be categorised as X-ray tubes that include a stationary anode, or as X-ray tubes that include a rotating anode. In X-ray tubes with a stationary anode, the anode is maintained in a stationary position with respect to the cathode during the generation of X-rays. In X-ray tubes with a rotating anode, the anode is rotated with respect to the cathode during the generation of X-rays. In both types of X-ray tubes, the anode can reach a high temperature during the generation of X-ray radiation. For instance, the surface of rotating anode may reach a temperature of temperature of 2000 K or more at the focal spot where the electrons impinge on the anode. This induces high thermal stresses in the anode. As compared to the use of a stationary anode, a rotating anode ensures that the electrons impinge on different regions of the anode over time, thereby acting to reduce such thermal stresses.

In order to ensure that the anodes of both types of X-ray tube operate reliably, it is important to avoid overheating of the anode. Overheating of the anode can be caused by excessive use of the X-ray tube, and also by arcing. Overheating of the anode can cause the surface of the anode to melt, or to roughen, or even to crack. This can ultimately result in the failure of the anode. Consequently, it is useful to be able to monitor the temperature of the anode in order assess its health. However, obtaining such a measurement of the anode temperature is far from trivial due to the high temperature, high vacuum, high voltage potential, and electromagnetically-shielded environment, within the X-ray tube. Consequently, the anode temperature is often estimated using thermal modelling.

A document U.S. Pat. No. 2,315,593A relates to a method of protecting rotating anode X-ray tubes. This document discloses a technique for monitoring a temperature of an anode of an X-ray tube in a de-energized condition. This document discloses that by determining the general surface temperature of the anode, it is possible to tell whether a dangerous general heating has occurred to such an extent as to render immediate use of the tube for X-ray production unsafe.

A document DE2312336A1 discloses an arrangement for measuring the anode temperature of an X-ray tube. The arrangement includes a detector that is arranged near the anode and which responds to the light or heat rays emanating from the anode.

However, there remains a need to provide improved measurements of the temperature of an anode of an X-ray tube.

### SUMMARY OF THE INVENTION

According to one aspect of the present disclosure, a system for determining a temperature of an anode of an X-ray tube, is provided. The system includes an X-ray tube, and an electrical circuit. The X-ray tube comprises:
an anode configured to generate X-ray radiation in response to impinging electrons; and
a cathode for generating the electrons and/or a grid for deflecting the electrons prior to the electrons impinging on the anode.

The cathode and/or the grid comprises at least one resistive element configured to receive thermal radiation emitted by the anode. The at least one resistive element is provided by at least a portion of the cathode and/or at least a portion of the grid, respectively. An electrical resistance of the at least one resistive element is dependent on a temperature change induced in the resistive element due to the received thermal radiation. The electrical circuit is configured to determine a value of a temperature of the anode based on a measurement of a value of the at least one electrical resistance during the generation of X-ray radiation by the anode. The electrical circuit is further configured to output the value of the temperature of the anode.

Thus, the system provides a temperature measurement of the anode during the generation of X-ray radiation by the anode. The ability to measure the temperature of the anode during the generation of X-ray radiation has several advantages over an “off-state” measurement during a period when no X-ray radiation is generated. For instance, the anode temperature is highest during the generation of X-ray radiation, and it is therefore during this period that the anode incurs the highest risk of overheating. It also offers the capability of switching-off the generation of X-ray radiation in order to prevent overheating of the anode. Moreover, since the system determines the anode temperature based on a measurement of the electrical resistance of a resistive element of the cathode and/or the grid, the anode temperature is provided without the need to include additional temperature sensors in the X-ray tube. Using the resistive element of the grid to determine the temperature of the anode may provide improved temperature sensitivity as compared to the resistive element of the cathode due to its relatively closer position to the anode than the cathode.

Further aspects, features, and advantages of the present disclosure will become apparent from the following description of examples, which is made with reference to the accompanying drawings.

### BRIEF DESCRIPTION OF THE DRAWINGS

FIG. 1 is a schematic diagram illustrating a first example of system 100 including an X-ray tube 120 and an electrical circuit 130, in accordance with some aspects of the present disclosure.

FIG. 2 is a schematic diagram illustrating the operation of a bolometer, in accordance with some aspects of the present disclosure.

FIG. 3 is a schematic diagram illustrating an example of a cathode 160 including a primary resistive element 180ₐ′ and a secondary resistive element 180_{b}′, a) in perspective view, b) in plan view, and c) in side-view, in accordance with some aspects of the present disclosure.

FIG. 4 is a schematic diagram illustrating a second example of system 100 including an X-ray tube 120 and an electrical circuit 130, in accordance with some aspects of the present disclosure.

FIG. 5 is a schematic diagram illustrating an example of a cathode 160 including a resistive element 180′ and a focusing element 210 for focusing thermal radiation emitted by the anode onto the resistive element 180′, a) in perspective view, b) in plan view, and c) in side-view, in accordance with some aspects of the present disclosure.

FIG. 6 is a schematic diagram illustrating an example of a cathode 160 including a resistive element 180′ having a plurality of segments 220₁, 220₂, a) in perspective view, b) in plan view, and c) in side-view, in accordance with some aspects of the present disclosure.

FIG. 7 is a flowchart illustrating an example of a method of generating a maintenance alert for an X-ray tube 120, in accordance with some aspects of the present disclosure.

### DETAILED DESCRIPTION OF EMBODIMENT

Examples of the present disclosure are provided with reference to the following description and figures. In this description, for the purposes of explanation, numerous specific details of certain examples are set forth. Reference in the specification to “an example”, “an implementation” or similar language means that a feature, structure, or characteristic described in connection with the example is included in at least that one example. It is also to be appreciated that features described in relation to one example may also be used in another example, and that all features are not necessarily duplicated in each example for the sake of brevity. For instance, features described in relation to one example of a system, may be implemented in other examples of the system. Moreover, features described in relation to a system that includes an X-ray tube and an electrical circuit, may be implemented in an X-ray imaging system, in a corresponding manner.

In the following description, reference is made to examples of an X-ray tube. In some examples, reference is made to the use of the X-ray tube in a medical imaging system. In this regard, the medical imaging system may be a projection X-ray imaging system, or a computed tomography “CT” imaging system. However, it is to be appreciated that the use of the X-ray tube is not limited to a medical imaging system, or indeed to medical applications. For instance, unless explicitly stated, the X-ray tube may be used in a wide range of application fields, including non-destructive testing, materials characterisation, and security, for example.

In some examples described herein, reference is made to operations that are performed by one or more processors. In this regard, the operations may be implemented by a single dedicated processor, or by a single shared processor, or by a plurality of individual processors, some of which can be shared. The operations may for instance be performed by processors that are shared within a networked processing architecture such as a client/server architecture, a peer-to-peer architecture, the Internet, or the Cloud. It is also noted that the operations that are performed by one or more processors may be provided in the form of a non-transitory computer-readable storage medium including computer-readable instructions stored thereon, which, when executed by at least one processor, cause the at least one processor to perform the operations. In other words, the operations may be implemented in a computer program product. The computer program product can be provided by dedicated hardware, or hardware capable of running the software in association with appropriate software.

The explicit use of the terms “processor” or “controller” should not be interpreted as exclusively referring to hardware capable of running software, and can implicitly include, but is not limited to, digital signal processor “DSP” hardware, read only memory “ROM” for storing software, random access memory “RAM”, a non-volatile storage device, and the like. Furthermore, examples of the present disclosure can take the form of a computer program product accessible from a computer-usable storage medium, or a computer-readable storage medium, the computer program product providing program code for use by or in connection with a computer or any instruction execution system. For the purposes of this description, a computer-usable storage medium or a computer readable storage medium can be any apparatus that can comprise, store, communicate, propagate, or transport a program for use by or in connection with an instruction execution system, apparatus, or device. The medium can be an electronic, magnetic, optical, electromagnetic, infrared, or a semiconductor system or device or propagation medium. Examples of computer-readable media include semiconductor or solid state memories, magnetic tape, removable computer disks, random access memory “RAM”, read-only memory “ROM”, rigid magnetic disks and optical disks. Current examples of optical disks include compact disk-read only memory “CD-ROM”, compact disk-read/write “CD-R/W”, Blu-Ray™ and DVD. As mentioned above, there remains a need to provide improved measurements of the temperature of an anode of an X-ray tube.

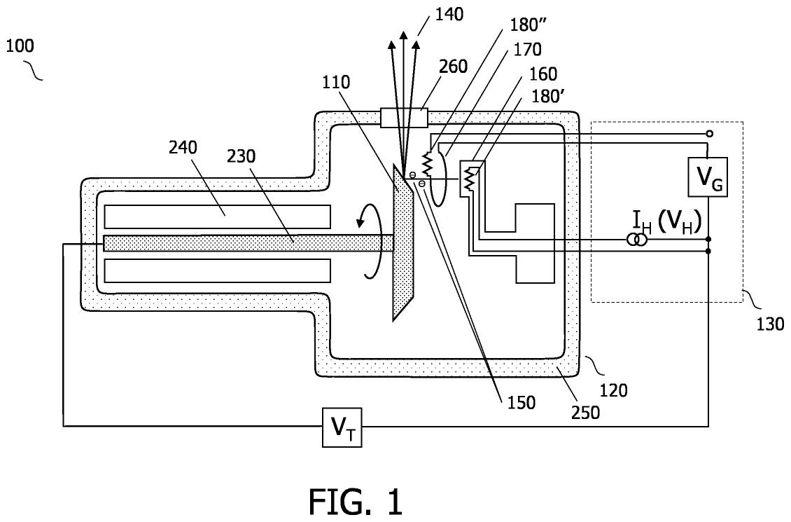

FIG. 1 is a schematic diagram illustrating a first example of system 100 including an X-ray tube 120 and an electrical circuit 130, in accordance with some aspects of the present disclosure. The system 100 includes an X-ray tube 120, and an electrical circuit 130. The X-ray tube 120 includes:
an anode 110 configured to generate X-ray radiation 140 in response to impinging electrons 150; and
a cathode 160 for generating the electrons 150 and/or a grid 170 for deflecting the electrons 150 prior to the electrons 150 impinging on the anode 110.

The cathode 160 and/or the grid 170 comprises at least one resistive element 180′, 180″ configured to receive thermal radiation emitted by the anode 110. An electrical resistance of the at least one resistive element 180′, 180″ is dependent on a temperature change induced in the resistive element due to the received thermal radiation. The electrical circuit 130 is configured to determine a temperature of the anode 110 based on a measurement of a value of the at least one electrical resistance during the generation of X-ray radiation 140 by the anode.

Thus, the system provides a temperature measurement of the anode during the generation of X-ray radiation by the anode. The ability to measure the temperature of the anode during the generation of X-ray radiation has several advantages over an “off-state” measurement during a period when no X-ray radiation is generated. For instance, the anode temperature is highest during the generation of X-ray radiation, and it is therefore during this period that the anode incurs the highest risk of overheating. It also offers the capability of switching-off the generation of X-ray radiation in order to prevent overheating of the anode. Moreover, since the system determines the anode temperature based on a measurement of the electrical resistance of a resistive element of the cathode and/or the grid, the anode temperature is provided without the need to include additional temperature sensors in the X-ray tube. Using the resistive element of the grid to determine the temperature of the anode may provide improved temperature sensitivity as compared to the resistive element of the cathode due to its relatively closer position to the anode than the cathode.

With reference to FIG. 1, the anode 110 may be formed from various materials, including metals such as tungsten, molybdenum, or copper, for example. The anode 110 may be a rotating anode, and which is configured to rotate when the X-ray tube is in-use, as indicated by the arrow in FIG. 1. The anode 110 may be coupled to a motor that includes an anode rotor 230 and a stator 240 for rotating the anode. The speed of rotation of the anode 110 may be in the order of 10,000 rpm. Alternatively, in other examples the anode 110 may remain stationary when the X-ray tube is in-use, and in which case a motor is not necessary.

The cathode 160 illustrated in FIG. 1 includes a resistive element 180′. The resistive element 180′ may be formed from various materials, including metals such as tungsten, for example. During use of the X-ray tube, an electrical current is applied to the resistive element 180′, which causes the cathode to generate electrons 150 via thermionic emission. In the example illustrated in FIG. 1, the electrical current I_{H} is applied to the resistive element 180′ by the electrical circuit 130, which results in a heating of the resistive element 180′, and consequently the generation of the electrons 150 via thermionic emission.

During use of the X-ray tube, a potential difference, V_{T}, which is often in the order of 20-200 kV, is applied between the anode 110 and the cathode 160. The resulting electrical field accelerates the electrons 150 from the cathode 160 towards the anode 110, causing them to impinge on the anode 110. The electrons 150 may be further guided towards the anode 110 by providing the cathode with a so-called “focusing cup” and applying an electrical charge to the focusing cup. X-ray radiation 140 that includes Bremsstrahlung, or “braking” X-ray radiation is generated by the anode 110 in response to the impinging electrons 150. The X-ray radiation 140 may also include spectral lines of characteristic X-ray radiation that are generated as a result of the impinging electrons 150 knocking orbital electrons out of the inner electron shells of atoms in the anode 110. The X-ray radiation 140 is emitted by the X-ray tube in the form of a beam.

With continued reference to FIG. 1, the X-ray tube 120 may also include a grid 170. The grid 170 is arranged between the cathode 160 and the anode 110. The grid 170 is used to deflect the electrons 150 prior to the electrons impinging on the anode 110. The grid 170 includes a resistive element 180″. The grid 170 may be formed from various materials, including metals such as tungsten, for example. The resistive element may be provided by a portion of the grid. The grid may be provided in various shapes. The electrons 150 are deflected by applying a potential difference Va between the grid and the anode 110 and/or the cathode 170. In the example illustrated in FIG. 1, the potential difference VG is applied between the grid and the cathode 160. The potential difference may be controlled in order to adjust factors such as the position and shape of the region of the anode 110 impinged by the electrons 150. These factors in-turn affect the shape of the beam of X-ray radiation 140 generated by the anode 110.

The anode 110, the cathode 160, and where present, the grid 170, are housed in a vacuum-containing envelope 250. The vacuum provides an undisturbed path for the electrons passing from the cathode 160 to the anode 110. The vacuum-containing envelope 250 may be formed from a glass, or a metal, for example. The vacuum-containing envelope may also include X-ray shielding (not illustrated in FIG. 1) surrounding the vacuum-containing envelope 250. The X-ray shielding may be formed from a metal, such as lead, for example. The vacuum-containing envelope may also include an X-ray window 260 for transmitting the X-ray radiation 140. The X-ray window 260 is formed from a material that is transparent to X-ray radiation. Various metals, such as beryllium, may be used for this purpose.

With continued reference to FIG. 1, in the illustrated example, the resistive element 180′ of the cathode 160 and/or the resistive element 180″ of the grid 170, receives thermal radiation emitted by the anode 110. In this regard, there may be a direct path between at least a portion of the resistive element 180′ of the cathode 160 and/or the at least a portion of the resistive element 180″ of the grid 170. Consequently, thermal radiation emitted by the anode 110 passes through the vacuum of the vacuum-containing envelope, where it is received by the resistive element 180′ and/or the resistive element 180″, causing an increase in the temperature of the resistive element 180′, 180″.

The resistive element 180′ and/or the resistive element 180″ has an electrical resistance that is dependent on a temperature change induced in the resistive element due to the received thermal radiation. As mentioned above, the resistive element 180′ may be formed from various materials, including metals such as tungsten. Materials such as metals, typically have a temperature-dependent resistance that is expressed as a temperature coefficient of resistance. This effect is therefore exploited in order to provide the electrical resistance that is dependent on a temperature change. The electrical circuit 130 is configured to determine a temperature of the anode 110 based on a measurement of a value of the electrical resistance of the resistive element 180 and/or the resistive element 180′ during the generation of X-ray radiation 140 by the anode.

Various measurement techniques are contemplated for use in the electrical circuit 130 to measure a value of the at least one electrical resistance during the generation of X-ray radiation 140 by the anode, some of which are described below. These may be used to determine the value of the at least one electrical resistance of the resistive element of the cathode, and likewise to determine the value of the at least one electrical resistance of the resistive element of the grid. In general, the electrical circuit 130 may include various components such as an analogue-to-digital converter “ADC” for measuring voltages or currents, a digital to analogue converter “DAC” for generating voltages of currents, and a processor for controlling the ADC, the DAC, and for calculating the resulting resistance of the resistive element 180′, 180″, and the temperature of the anode 110. In some examples, the electrical circuit 130 may include one or more filters for rejecting noise and interference, and thereby improving the sensitivity of the measurements.

In one measurement technique example, an electrical current is applied to the resistive element, and a potential difference is measured across the resistive element. The electrical resistance of the resistive element 180′ is then determined by dividing the measured voltage by the applied current. With reference to FIG. 1, this technique may be used to measure the electrical resistance of the resistive element 180′ of the cathode 160. In this case, the electrical resistance is determined by dividing a potential difference V_{H} that is measured across the resistive element by an electrical current I_{H} that is applied to the resistive element 180′ of the cathode 160, in order to heat the resistive element 180′. The electrical resistance of the resistive element 180″ of the grid 170 may be determined in a similar manner by applying an electrical current to the grid and dividing a potential difference that is measured across the resistive element by the applied electrical current.

The above-described measurement technique may be implemented as a four-terminal sensing measurement, also referred-to as a four-wire resistance measurement. In this technique, two electrical wires are used to apply the electrical current to the resistive element 180′, 180″, and two separate wires are coupled to positions local to the resistive element 180′, 180″ in order to measure the potential difference across the resistive element. This technique has the advantage of providing a more accurate measurement of the resistive element because the measurement of the potential difference omits potential differences along the electrical wires that are used to apply the electrical current to the resistive element.

In another measurement technique example, instead of applying a current to the resistive element, a voltage is applied to the resistive element 180′, 180″, and a current passing through the resistive element is measured. In this case, the electrical resistance of the resistive element 180′, 180″ is determined by dividing the applied voltage by the measured current.

In a related measurement technique example, the applied voltage, or current, in the above examples, may be an alternating “AC” current or voltage at a specified frequency. In this case, an amplitude of the measured voltage, or current, is measured at the specified frequency using a lock-in amplifier, also known as a phase sensitive detector, and used in a similar manner to determine the electrical resistance of the resistive element 180′, 180″. A lock-in amplifier, or phase sensitive detector, offers the ability to reject signals outside of a predetermined bandwidth centred on the specified frequency. Consequently, measurement noise, and also DC measurements, may be rejected, thereby improving the sensitivity of the electrical resistance measurement.

In another measurement technique example, a Wheatstone Bridge, is used to measure the electrical resistance of the resistive element 180′, 180″.

Having determined the electrical resistance of the resistive element 180′, 180″, the temperature of the anode may then be determined based on a functional relationship between the anode temperature and the resistance of the resistive element. The electrical circuit 130 may include one or more processors that receive the measurement of the value of the at least one electrical resistance, and determine the temperature of the anode 110 based on the functional relationship between the anode temperature and the resistance of the resistive element.

The functional relationship may be determined empirically. For instance, experimental measurements of the anode temperature and the electrical resistance may be acquired at different X-ray tube currents to provide the functional relationship. The anode temperature may be measured using a pyrometer, for example. The functional relationship may alternatively be determined from a thermal model of the X-ray tube. The functional relationship may be stored as look-up table, or modelled using an equation, and which is subsequently consulted in order to determine the temperature of the anode 110 from a measured value of the resistance. One or more correction factors may also be applied to the functional relationship in order to account for factors such as an amount of current applied to the cathode, an ambient temperature, and so forth.

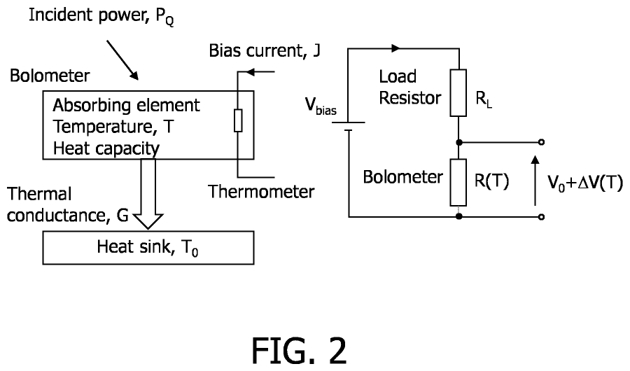

In one example the resistive element is configured as a bolometer. This example is described with reference to FIG. 2, which is a schematic diagram illustrating the operation of a bolometer, in accordance with some aspects of the present disclosure. A bolometer is a device for measuring incident radiant power using an “absorbing element” that absorbs thermal radiation. The absorbing element has a temperature-dependent electrical resistance. With reference to FIG. 2, the Bolometer illustrated on the left-hand side of FIG. 2 includes an Absorbing element and a Heat sink. The Absorbing element has an unknown temperature, T, and is thermally coupled to the Heat sink via a Thermal conductance, G. The Absorbing element has a temperature-dependent resistance R(T). The electrical circuit illustrated on the right-hand side of FIG. 2 may be used to determine the temperature, T, of the Absorbing element, via its temperature-dependent resistance R (T). The electrical circuit applies a bias voltage V_{bias} to the Absorbing element via a load resistor R_{L}. This gives rise to a bias current, J, in the bolometer. In the absence of incident radiation power P_{Q}, the Absorbing element is in thermal equilibrium with the Heat sink and the temperature of the Absorbing element is T₀. In this state, the voltage across the bolometer that is measured by the electrical circuit is V₀. In the presence of incident radiation power P_{Q}, the temperature of the Absorbing element increases by a temperature change ΔT according to the Equation:

$$Δ T = T - {T}_{0} = \frac{{P}_{Q} + {P}_{El} ( T )}{G} \qquad Equation 1$$

and wherein P_{El}(T) is the electrical power dissipated in the Absorbing element by the bias current, J. In this state the voltage across the bolometer that is measured by the electrical circuit increases to V₀+ΔV(T). This voltage is therefore dependent on the value of the resistance of the Absorbing element, R(T), and the conductance G. A measurement of his voltage may therefore be used to determine the incident radiation power P_{Q}, via the temperature change ΔT of the Absorber element, and consequently to determine the temperature of the anode, as described below. Further details on the optimisation of the bolometer are described in a document by Chasmar, R. P., et al., “Theory and Performance of Metal Bolometers”. Journal of the Optical Society of America Vol. 46, Issue 7, pp. 469-477 (1956).

With reference to the system illustrated in FIG. 1, in this example, the resistive element 180′, 180″, serves as the Absorbing element described above with reference to FIG. 2. The resistive element 180′, 180″, is thermally coupled to a portion of the X-ray tube. For instance, the resistive element 180′ may be thermally coupled to a portion of the cathode, or the resistive element 180″ may be thermally coupled to another support structure within the vacuum-containing envelope 250. Thus, in this example, the at least one resistive element 180′, 180″ comprises a value of a thermal conductance G between the resistive element and a portion of the X-ray tube 120. In this example, the electrical circuit 130 further comprises one or more processors. The one or more processors are configured to receive the measurement of the value of the at least one electrical resistance, and to determine the temperature of the anode 110 based on the measurement of the value of the at least one electrical resistance and the corresponding value of the thermal conductance. In this operation, the temperature of the anode may be determined using a functional relationship between the anode temperature and the resistance of the resistive element, and the conductance between the resistive element and a portion of the X-ray tube 120.

The use of various configurations of the resistive element 180′, 180″ is also contemplated, some of which are described in more detail below. In general, the temperature of the anode may be determined from these configurations using the measurement techniques described above.

In one example configuration, the resistive element 180′ of the cathode is simultaneously used to generate electrons via thermionic emission, and to determine a temperature of the anode based on its electrical resistance. This configuration is illustrated in FIG. 1. In this example, the X-ray tube 120 comprises the cathode 160, and the electrical circuit 130 is further configured to apply an electrical current I_{H} to the at least one resistive element 180′ of the cathode for heating the at least one resistive element and for generating the electrons 150 via thermionic emission. The electrical circuit 130 is configured to determine the temperature of the anode 110 based on the measurement of the value of the at least one electrical resistance of the at least one resistive element 180′ of the cathode during the application of the electrical current I_{H} to the at least one resistive element.

In this example, the measured temperature of the resistive element is impacted by the self-heating of the resistive element due to the electrical current Tx as well as the thermal radiation received from the anode. A correction may therefore be applied to the measured resistance of the resistive element 180′ in order to compensate for the self-heating of the resistive element. The sensitivity of the resistance measurement in this example may also be improved using the lock-in amplifier measurement technique, or the four-terminal sensing measurement technique, described above.

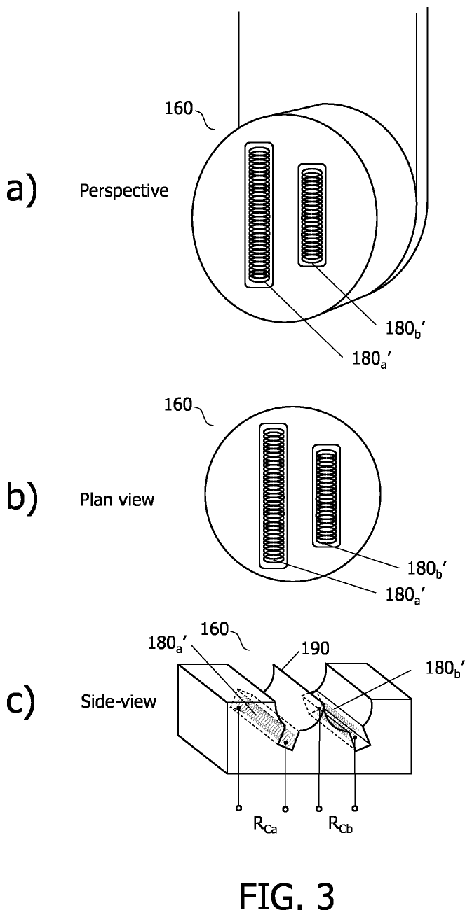

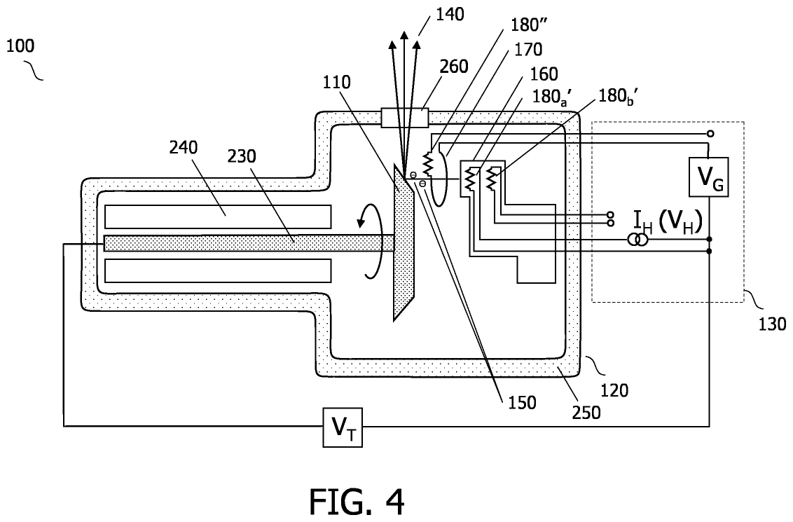

In another example configuration, the resistive element 180′ of the cathode includes a primary resistive element 180ₐ′ and a secondary resistive element 180_{b}′. An electrical current is applied to the primary resistive element 180ₐ′ to heat the primary resistive element and to generate electrons 150 via thermionic emission, and the temperature of the anode 110 is determined based on a measurement of a value of the electrical resistance of the secondary resistive element 180_{b}′. This example is described with reference to FIG. 3, and FIG. 4.

FIG. 3 is a schematic diagram illustrating an example of a cathode 160 including a primary resistive element 180ₐ′ and a secondary resistive element 180_{b}′, a) in perspective view, b) in plan view, and c) in side-view, in accordance with some aspects of the present disclosure. In the example illustrated in FIG. 3, the resistive elements 180ₐ′ and 180_{b}′ are provided in the form of coiled wire. The wire may be formed from various metals such as tungsten, for example. In other examples, different types of resistive elements may be provided. For instance, the resistive elements may be provided with different shapes or sizes, or they may be provided by planar undulating structures, or they may be formed from different materials. The cathode illustrated in FIG. 3 may be referred-to as a “dual-filament” cathode. Such cathodes are employed in some existing X-ray tubes in order to provide redundancy, or to generate a focal spot, and consequently a beam of X-ray radiation, with a desired shape.

FIG. 4 is a schematic diagram illustrating a second example of system 100 including an X-ray tube 120 and an electrical circuit 130, in accordance with some aspects of the present disclosure. Items in FIG. 4 having the same labels as items in FIG. 3 refer to the same features and provide corresponding functionality. A description of the duplicated features is not repeated here for the sake of brevity. In addition to the items illustrated in FIG. 3, FIG. 4 includes a secondary resistive element 180_{b}′. Electrical connections to the secondary resistive element 180_{b}′ are also provided to the electrical circuit 130.

In this example, the X-ray tube 120 comprises the cathode 160, and the at least one resistive element of the cathode comprises a primary resistive element 180ₐ′ and a secondary resistive element 180_{b}′. The electrical circuit 130 is configured to apply an electrical current to the primary resistive element 180ₐ′ for heating the primary resistive element and for generating the electrons 150 via thermionic emission. The electrical circuit 130 is configured to determine the temperature of the anode 110 based on a measurement of a value of the electrical resistance of the secondary resistive element 180_{b}′ during the application of the electrical current to the primary resistive element 180ₐ′.

In this example, separate resistive elements 180ₐ′ and 180_{b}′ are used to generate the electrons 150 via thermionic emission, and to determine the temperature of the anode 110. Consequently, this example avoids the temperature increase due to self-heating in the resistive element that is used to measure the anode temperature that was described with reference to FIG. 1. By avoiding this temperature increase, the accuracy of the measured temperature of the anode may be improved.

In this example, the primary resistive element 180ₐ′ and the secondary resistive element 180_{b}′ may have the same shapes and/or sizes, or they may have different shapes and/or sizes. As described above, the shape and size of the resistive element affect the shape and size of the focal spot on the anode, and consequently the shape and size of the emitted beam of X-ray radiation.

In a related example, the cathode 160 comprises a radiation shield 190. The radiation shield is disposed between the primary resistive element 180ₐ′ and the secondary resistive element 180_{b}′ for preventing thermal radiation emitted by the primary resistive element 180ₐ′ from reaching the secondary resistive element 180_{b}′ via a direct path.

An example of the radiation shield 190 is illustrated in FIG. 3c). The radiation shield 190 helps to improve the accuracy of the temperature measurement of the anode 110. The radiation shield 190 may be formed from various materials, including metals, and ceramics. In the latter case, the thermal insulation provided by a ceramic results in improved thermal isolation between the primary resistive element 180ₐ′ and the secondary resistive element 180_{b}′. The radiation shield may be cooled in order to further improve the thermal isolation. The radiation shield may be cooled passively, for instance by thermally coupling the radiation shield to a heatsink, or it may be cooled actively, for example by using liquid cooling.

In another related example, the electrical circuit 130 is configured to correct the measurement of the value of the electrical resistance of the secondary resistive element 180_{b}′ for thermal radiation received by the secondary resistive element from the primary resistive element 180ₐ′. In this example, the electrical circuit 130 is configured to determine the temperature of the anode 110 based on the corrected measurement of the value of the electrical resistance of the secondary resistive element 180_{b}′.

By correcting the measurement of the value of the electrical resistance in this example, a more accurate measurement of the anode temperature may be provided. The measurement of the value of the electrical resistance of the secondary resistive element 180_{b}′ may be corrected based on a value of a current applied to the primary resistive element 180ₐ′, for example. The value of this current is typically recorded during the operation of the X-ray tube. The value of the current may therefore be used to consult a look-up table or an equation to perform the correction. The correction may be performed by one or more processors of the electrical circuit 130, for example.

In another related example, the cathode 160 includes a third resistive element. The secondary resistive element and the third resistive element receive thermal radiation emitted by different portions of the anode 110. In this example the at least one resistive element of the cathode includes a primary resistive element 180ₐ′, a secondary resistive element 180_{b}′, and at least a third resistive element. The secondary resistive element and the at least a third resistive element are configured to receive thermal radiation emitted by different portions of the anode 110. The electrical circuit 130 is configured to determine the temperature of the anode 110 based further on a measurement of the value of the electrical resistance of the at least a third resistive element during the generation of X-ray radiation 140 by the anode.

In this example, different temperature measurements of the anode are obtained from the secondary, and the at least a third, resistive elements. Since the secondary resistive element and the at least a third resistive element receive thermal radiation emitted by different portions of the anode, the temperatures of different portions of the anode may be determined. In this example, the at least a third resistive element need not necessarily provide the capability of generating electrons via thermionic emission. This increases the freedom of positioning the at least a third resistive element such that it receives thermal radiation from a desired portion of the anode 110. The measurements from the different portions of the anode may be used to generate a spatially-resolved image of the anode temperature. This helps to identify temperature hotspots on the surface of the anode that might be missed if only a single measurement of the anode temperature is provided.

In another example, a focussing element is provided. In this example, the X-ray tube 120 comprises the cathode 160, and the cathode comprises a focussing element 210. The focussing element is configured to focus thermal radiation emitted by the anode 110 onto the at least one resistive element of the cathode.

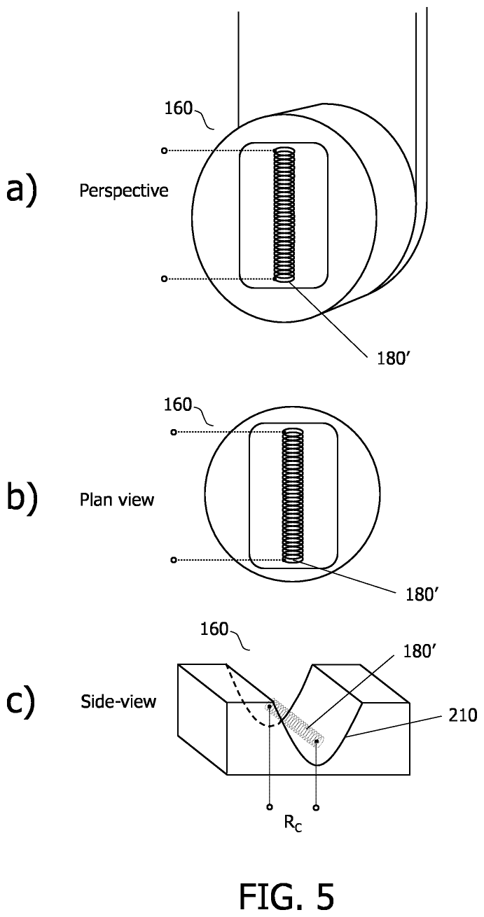

FIG. 5 is a schematic diagram illustrating an example of a cathode 160 including a resistive element 180′ and a focusing element 210 for focusing thermal radiation emitted by the anode onto the resistive element 180′, a) in perspective view, b) in plan view, and c) in side-view, in accordance with some aspects of the present disclosure. Items in FIG. 5 having the same labels as items in FIG. 3 refer to the same features and provide corresponding functionality. A description of the duplicated features is not repeated here for the sake of brevity. In contrast to FIG. 3, the cathode 160 illustrated in FIG. 5 includes only a single resistive element 180′, however it is to be appreciated that a focusing element may also be provided for one or more of the resistive elements illustrated in FIG. 3 in a similar manner. In addition to the items illustrated in FIG. 3, FIG. 5 includes a focusing element 210, which in this example is provided by a parabolic mirror. The resistive element 180′ is located at the focus of the parabolic mirror in order to focus thermal radiation received from the anode 110 onto the resistive element 180′, and thereby improve the sensitivity of the resistive element to thermal radiation. The parabolic mirror may include a metal such a tungsten, in order to provide a durable reflecting surface. In other examples, the focusing element may have a different shape to a parabola. It is noted that the focusing element 210 differs from the “focusing cup” mentioned above. A cathode of an X-ray tube may include a focusing cup that serves to focus the electric field between the cathode 160 and the anode 110 and thereby guide the paths of the electrons 150 as they travel between the cathode 160 and the anode 110. However, the shapes of typical focusing cups renders them unsuitable for focussing thermal radiation emitted by the anode 110 onto a resistive element of the cathode.

In a related example, one or more thermal radiation-reflecting structures may be provided between the anode and the resistive element(s) in order to similarly improve the detection efficiency of the resistive element(s) to thermal radiation. For example, one or more optical elements, such as a collimator, or a mirror, may be provided between the anode and the resistive element(s) and arranged to guide the thermal radiation emitted by the anode onto the resistive element(s). Some X-ray tubes include structures such as a quadrupole for magnetically deflecting the paths of electrons prior to the electrons impinging on the anode. Thus, in a related example, portions of such structures may be shaped so as to guide the thermal radiation emitted by the anode onto the resistive element(s).

In another example, the at least one resistive element 180′, 180″ of the cathode 160 and/or the grid 170, comprises a plurality of segments 220₁, 220₂. Each segment represents a portion of the electrical resistance of the at least one resistive element; and each segment is configured to receive thermal radiation emitted by a different portion of the anode 110. In this example, the electrical circuit 130 is configured to determine a temperature of each portion of the anode 110 based on a measurement of the value of the electrical resistance of the corresponding segment during the generation of X-ray radiation 140 by the anode.

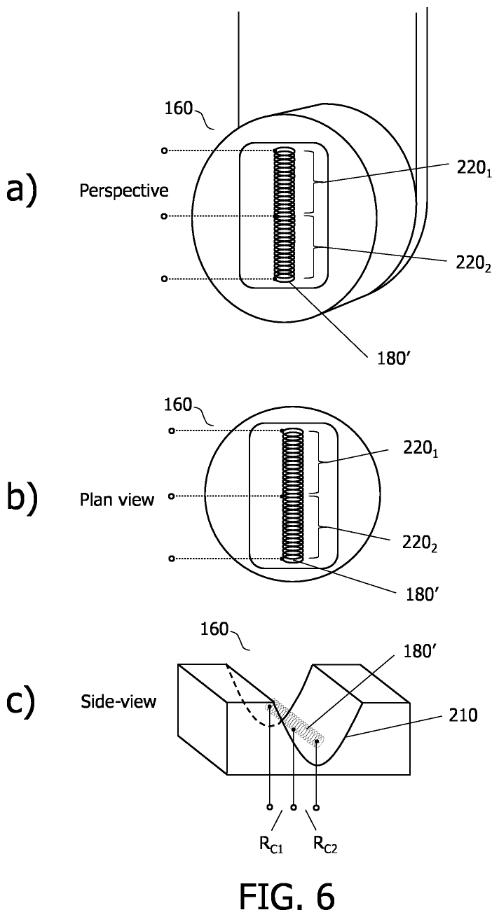

An implementation of this example with a segmented cathode is described with reference to FIG. 6, which is a schematic diagram illustrating an example of a cathode 160 including a resistive element 180′ having a plurality of segments 220₁, 220₂, a) in perspective view, b) in plan view, and c) in side-view, in accordance with some aspects of the present disclosure. Items in FIG. 6 having the same labels as items in FIG. 5 refer to the same features and provide corresponding functionality. A description of the duplicated features is not repeated here for the sake of brevity. In addition to the items illustrated in FIG. 5, the example illustrated in FIG. 6 also includes a plurality of segments 220₁, 220₂. It is noted that whilst the example illustrated in FIG. 6 includes a focusing element 210, the focusing element 210 is not essential to the functioning of the segments 220₁, and 220₂ and its presence should be seen as optional.

In the example illustrated in FIG. 6, the segments 220₁, 220₂ of the resistive element 180′ are provided by including an additional electrical contact on the resistive element 180′. This divides the resistive element 180′ into the segments 220₁, and 220₂, having corresponding resistances R_{C1} and R_{C2}. Owing to their separated positions, the segments 220₁, and 220₂ receive thermal radiation from different portions of the anode. In the example illustrated in FIG. 6, a current may be applied to the resistive element 180′ in order to generate electrons via thermionic emission, as described with reference to FIG. 1. In contrast to the example described with reference to FIG. 1, the additional contact illustrated in FIG. 6 facilitates a separate measurement of the resistances R_{C1} and R_{C2}. These resistances may then be used to determine the temperatures of the corresponding portions of the anode 110.

In the example illustrated in FIG. 6, the segments 220₁, and 220₂ are contiguous. However, in other examples, the segments may be provided in a different manner. For instance, the segments may be defined in a side-by-side positions, or they may have different shapes.

In a related example, the grid 170 may be divided into segments by including additional contacts on the resistive element(s) of the grid in a similar manner. Owing to their separate positions, the segments of the grid likewise receive thermal radiation from different portions of the anode. Consequently these segments of the resistive element(s) of the grid may be used to determine the temperatures of the different portions of the anode in a similar manner.

In another example, the X-ray tube includes a secondary electron capture electrode. A secondary electron capture electrode is disposed between the grid 170 and the anode 110 and serves to capture secondary electrons that are emitted from the anode 110 as a consequence of the impinging electrons. The secondary electron capture electrode may also include at least one resistive element. The at least one resistive element of the secondary electron capture electrode may be used in a similar manner to the resistive element(s) of the cathode, or the grid, to determine the temperature of the anode. Thus, in this example, a secondary electron capture electrode is disposed between the grid and the anode and serves to capture secondary electrons that are emitted from the anode as a consequence of the impinging electrons. The secondary electron capture electrode comprises at least one resistive element configured to receive thermal radiation emitted by the anode. An electrical resistance of the at least one resistive element is dependent on a temperature change induced in the resistive element due to the received thermal radiation. The electrical circuit 130 is configured to determine a temperature of the anode 110 based on a measurement of a value of the at least one electrical resistance during the generation of X-ray radiation 14 by the anode.

Since the secondary electron capture electrode is disposed relatively closer to the anode than either the grid or the cathode, the use of a resistive element of the secondary electron capture electrode to determine the anode temperature may provide improved temperature sensitivity as compared to the use of a resistive element of the cathode or the grid.

In the examples described above, an off-state temperature of the anode 110 may also be determined during a period wherein there is no generation of X-ray radiation 140 by the anode. In addition to the temperature measurements described above, and which are made during the generation of X-ray radiation 140 by the anode, the off-state temperature of the anode 110 provides additional information that may be used to assess the operation of the anode. For instance, the off-state temperature of the anode 110 may be measured at one or more points in time during a cool-down period after the generation of X-ray radiation 140 has ceased in order to determine the cooling rate of the anode. The cooling rate of the anode may provide additional information on the anode health. Likewise, an off-state temperature of the anode 110 may be performed at one or more points in time prior to the generation of X-ray radiation 140. Such information may also be used to determine whether a heating rate of the anode is within specified limits, and thereby limit the risk of damage to the anode during this period.

Thus, in one example, the electrical circuit 130 is configured to determine an off-state temperature of the anode 110, the off-state temperature being determined based on a measurement of a value of the at least one electrical resistance during a period wherein there is no generation of X-ray radiation 140 by the anode.

In this example, the electrical circuit 130 may include a computer readable storage medium configured to record the measurement(s) of the off-state temperature of the anode 110. In the example described with reference FIG. 3 and FIG. 4 in which the cathode 160 includes a primary resistive element 180ₐ′ and a secondary resistive element 180_{b}′, both the primary resistive element 180ₐ′ and the secondary resistive element 180_{b}′ may be used to measure the off state temperature. As described above, the primary resistive element 180ₐ′ and the secondary resistive element 180_{b}′ may receive thermal radiation from different portions of the anode by virtue of them being disposed in different locations at the cathode. Consequently, the primary resistive element 180ₐ′ and the secondary resistive element 180_{b}′ may be used to provide off-state temperature measurements from different portion of the anode.

In one example, the electrical circuit 130 is further configured to generate an alarm and/or to trigger a change in operation of the X-ray tube 120, if a temperature of the anode 110 meets a specified condition.

Examples of specified conditions that may be used to generate an alarm and/or to trigger a change in operation of the X-ray tube 120 in this example include a temperature of the anode reaching a specified value, or a rate of change of the temperature exceeding a specified value. The alarm may be provided as an output signal in various forms, including in audio and visual form. The alarm provides an indication that the specified condition has been met. The alarm may also include a warning of various use limitations of the X-ray tube, such as for example the ability of the X-ray tube to only perform scans of a specified type, or a specified duration, or at a specified frequency. Alternatively, or additionally, the alarm may result in the generation of a maintenance alert. The maintenance alert indicates the need for a maintenance operation to be performed on the X-ray tube. The maintenance alert may for instance indicate that an operation of the X-ray tube should be verified, or that the X-ray tube should be replaced. The maintenance alert may be communicated in various ways, including locally to a user of the X-ray tube, or to a service department locally within the medical facility or at a remote location. Thus, the maintenance alert may be transmitted via a communication network. The maintenance alert may be transmitted via a communication network in order to automatically schedule a service call, or to automatically schedule a service call subject to user confirmation of a prompt suggesting the need for a service call, for instance.

Examples of a change in operation of the X-ray tube 120 that may be triggered in this example include switching-off the generation of X-ray radiation 140 by the anode, or adjusting a depth or a periodicity of modulation of the generated X-ray radiation 140, or reducing an operating voltage of the X-ray tube, or reducing a tube current of the X-ray tube, or adjusting a focusing of the electrons 150 onto the anode 110. Such measures may advantageously protect the anode by reducing the risk of overheating in future.

In another example, the system 100 described above may be included in an X-ray imaging system.

In another example, a computer-implemented method of generating a maintenance alert for an X-ray tube 120, is provided. The method includes:
receiving S110 the temperature of the anode 110 from the system according to any previous claim; and
generating S120 a maintenance alert based on the received temperature.

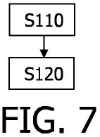

This example is illustrated in FIG. 7, which is a flowchart illustrating an example of a method of generating a maintenance alert for an X-ray tube 120, in accordance with some aspects of the present disclosure. The maintenance alert may be communicated to a remote location via a communication network. The maintenance alert may for instance indicate that an operation of the X-ray tube should be verified, or that the X-ray tube should be replaced, as described above. The maintenance alert may be triggered subject to the specified conditions described above.

The above examples are to be understood as illustrative of the present disclosure, and not restrictive. Further examples are also contemplated. For instance, any of the example systems 100 described above may be included in the X-ray imaging system. It is to be understood that a feature described in relation to any one example may be used alone, or in combination with other described features, and may be used in combination with one or more features of another of the examples, or a combination of other examples. Furthermore, equivalents and modifications not described above may also be employed without departing from the scope of the invention, which is defined in the accompanying claims. In the claims, the word “comprising” does not exclude other elements or operations, and the indefinite article “a” or “an” does not exclude a plurality. The mere fact that certain features are recited in mutually different dependent claims does not indicate that a combination of these features cannot be used to advantage. Any reference signs in the claims should not be construed as limiting their scope.

1. A system for determining a temperature of an anode of an X-ray tube, the system comprising an X-ray tube, and an electrical circuit;
wherein the X-ray tube comprises:
an anode configured to generate X-ray radiation in response to impinging electrons; and
a cathode for generating the electrons and/or a grid for deflecting the electrons prior to the electrons impinging on the anode;
wherein the cathode and/or the grid comprises at least one resistive element configured to receive thermal radiation emitted by the anode, the at least one resistive element being provided by at least a portion of the cathode and/or at least a portion of the grid, respectively, and wherein an electrical resistance of the at least one resistive element is dependent on a temperature change induced in the resistive element due to the received thermal radiation; and
wherein the electrical circuit is configured to determine a value of the temperature of the anode based on a measurement of a value of the at least one electrical resistance during the generation of X-ray radiation by the anode; and
wherein the electrical circuit is further configured to output the value of the temperature of the anode.

2. The system according to claim 1, wherein the X-ray tube comprises the cathode, and wherein the electrical circuit is further configured to apply an electrical current to the at least one resistive element of the cathode for heating the at least one resistive element and for generating the electrons via thermionic emission; and
wherein the electrical circuit is configured to determine the value of the temperature of the anode based on the measurement of the value of the at least one electrical resistance of the at least one resistive element of the cathode during the application of the electrical current to the at least one resistive element.

3. The system according to claim 1, wherein the X-ray tube comprises the cathode, and wherein the at least one resistive element of the cathode comprises a primary resistive element and a secondary resistive element; and
wherein the electrical circuit is further configured to apply an electrical current to the primary resistive element for heating the primary resistive element and for generating the electrons via thermionic emission; and
wherein the electrical circuit is configured to determine the value of the temperature of the anode based on a measurement of a value of the electrical resistance of the secondary resistive element during the application of the electrical current to the primary resistive element.

4. The system according to claim 3, wherein the cathode further comprises a radiation shield; and
wherein the radiation shield is disposed between the primary resistive element and the secondary resistive element for preventing thermal radiation emitted by the primary resistive element from reaching the secondary resistive element via a direct path.

5. The system according to claim 3, wherein the electrical circuit is further configured to correct the measurement of the value of the electrical resistance of the secondary resistive element for thermal radiation received by the secondary resistive element from the primary resistive element; and
wherein the electrical circuit is configured to determine the value of the temperature of the anode based on the corrected measurement of the value of the electrical resistance of the secondary resistive element.

6. The system according to claim 3, wherein the at least one resistive element further comprises at least a third resistive element; and
wherein the electrical circuit is configured to determine the value of the temperature of the anode based further on a measurement of the value of the electrical resistance of the at least a third resistive element during the generation of X-ray radiation by the anode; and
wherein the secondary resistive element and the at least a third resistive element are configured to receive thermal radiation emitted by different portions of the anode.

7. The system according to claim 1, wherein the X-ray tube comprises the cathode;
wherein the cathode further comprises a focussing element; and
wherein the focussing element is configured to focus thermal radiation emitted by the anode onto the at least one resistive element of the cathode.

8. The system according to claim 1, wherein the electrical circuit is further configured to determine a value of an off-state temperature of the anode, the value of the off-state temperature being determined based on a measurement of a value of the at least one electrical resistance during a period wherein there is no generation of X-ray radiation by the anode.

9. The system according to claim 1, wherein the at least one resistive element of the cathode and/or the grid, comprises a plurality of segments, each segment representing a portion of the electrical resistance of the at least one resistive element; and wherein each segment is configured to receive thermal radiation emitted by a different portion of the anode; and
wherein the electrical circuit is configured to determine a value of a temperature of each portion of the anode based on a measurement of the value of the electrical resistance of the corresponding segment during the generation of X-ray radiation by the anode.

10. The system according to claim 1, wherein the electrical circuit is configured to apply to the at least one resistive element an alternating current or an alternating voltage at a specified frequency, and wherein the measurement of the value of the at least one electrical resistance is determined based on a measurement of an alternating current passing through the at least one electrical resistance, or a measurement of an alternating voltage across the at least one electrical resistance, at the specified frequency.

11. The system according to claim 1, wherein the electrical circuit further comprises one or more processors;
wherein the one or more processors are configured to:
receive the measurement of the value of the at least one electrical resistance;
determine the value of the temperature of the anode based on a functional relationship between the anode temperature and the resistance of the resistive element; and
output the value of the temperature of the anode.

12. The system according to claim 1, wherein the at least one resistive element comprises a value of a thermal conductance between the resistive element and a portion of the X-ray tube; and
wherein the electrical circuit further comprises one or more processors; and
wherein the one or more processors are configured to receive the measurement of the value of the at least one electrical resistance, and to determine the value of the temperature of the anode based on the measurement of the value of the at least one electrical resistance and the corresponding value of the thermal conductance.

13. The system according to claim 1, wherein the electrical circuit is further configured to generate an alarm and/or to trigger a change in operation of the X-ray tube, if the value of the temperature of the anode meets a specified condition.

14. An X-ray imaging system comprising the system according to claim 1.

15. A computer-implemented method of generating a maintenance alert for an X-ray tube, the method comprising:
receiving the value of the temperature of the anode from the system according to claim 1; and
generating a maintenance alert based on the received value of the temperature.
